(19) United States
(12) Patent Application Publication
(10) Pub. No.: US 2026/0295646 A1
(43) Pub. Date: Oct. 1, 2026

(54) METHOD FOR EXTRACTING A SOLID ENERGETIC MATERIAL FROM CONTAMINATED SOIL

(71) Applicant: ARIANEGROUP SAS, LES MUREAUX (FR)

(72) Inventor: Thibault DERODE, LE HAILLAN (FR)

(21) Appl. No.: 19/489,084

(22) PCT Filed: May 28, 2024
(86) PCT No.: PCT/FR2024/050681

§ 371 Date: Dec. 1, 2025

(30) Foreign Application Priority Data
Jun. 2, 2023 (FR) FR2305530

(51) Int. Cl. B09C 1/08; A62D 3/20; A62D 3/38; A62D 101/06; A62D 101/26; A62D 101/28; B09C 1/02

(52) U.S. Cl. CPC B09C 1/08; B09C 1/02; A62D 3/20; A62D 3/38; A62D 2101/06; A62D 2101/26; A62D 2101/28

(57) ABSTRACT

A method of extracting solid energetic material from contaminated soil including a mixture of energetic material with plant substances, mineral aggregates and metal parts, the method including a sieving and washing of the contaminated soil to recover the mixture and remove the earth and sand possibly present, a first densimetric separation between a light fraction including the plant substances and a heavy fraction including the energetic material, the mineral aggregates and the metal parts, by immersing the mixture thus recovered in a water bath, an extraction of the heavy fraction obtained during the first densimetric separation, a drying or draining of the heavy fraction thus extracted, a second densimetric separation between the energetic material and the mineral aggregates and the metal parts, and extracting the energetic material obtained as a result of the second densimetric separation.

### TECHNICAL FIELD

The present disclosure concerns a method for extracting a solid energetic material for the remediation of contaminated soil.

### PRIOR ART

The soil of former production or storage sites may be contaminated with explosive solid energetic materials. A densimetric sieving technique can be envisaged for extracting the energetic material and remediating the soil. However, this technique is sensitive to the geometrical shape of the materials, and the energetic material can be found in a mixture of elements of various shapes ranging from millimeter-sized particles to plates several tens of centimeters long in the case of powder B for example. In addition, contaminated soil will very frequently comprise centimeter-sized mineral aggregates and potentially metal parts (such as small pieces of hardware), which will not be separated from the energetic material during sieving. The presence of these parts can pose a pyrotechnic safety problem during the step of preparation for the destruction of the energetic material, which conventionally involves prior grinding.

DE 195 26 371, KR 2017 0113841 and US 2020/0094301 are known and disclose methods for treating contaminated soil. U.S. Pat. No. 6,121,506 is also known, which discloses a method for destroying energetic materials.

It is therefore desirable to have a method for treating soil contaminated with an energetic material that has improved efficiency and guarantees complete pyrotechnic safety for the subsequent treatment steps.

### DISCLOSURE OF THE INVENTION

The present disclosure relates to a method for extracting a solid energetic material from contaminated soil comprising a mixture of the energetic material with plant substances, mineral aggregates and metal parts, the method comprising:
a sieving and washing of the contaminated soil to recover said mixture and remove the earth and sand possibly present,
a first densimetric separation between a light fraction comprising the plant substances and a heavy fraction comprising the energetic material, the mineral aggregates and the metal parts, by immersing the mixture thus recovered in a water bath,
an extraction of the heavy fraction obtained during the first densimetric separation,
a drying or draining of the heavy fraction thus extracted,
a second densimetric separation between the energetic material on the one hand and the metal parts and mineral aggregates on the other hand by immersing the heavy fraction thus dried or drained in a brine bath of an alkali metal formate, said brine having a density higher than that of the energetic material and lower than each of the densities of the metal parts and mineral aggregates, and
an extraction of the energetic material obtained as a result of the second densimetric separation.

The invention is noteworthy in that it is based on the principle of densimetric separation, or separation by flotation, to separate the energetic material from metal parts and mineral aggregates.

During this step, the mineral aggregates and the metal parts flow to the bottom of the brine bath, while the energetic material floats on the surface and can thus be easily extracted. The brine allows the energetic material to be extracted with high efficiency regardless of its form, does not pose a pyrotechnic risk and allows simple separation. It also has a very low environmental impact and moderate viscosity, even at a high concentration of formate. In addition, the heavy fraction is dried or drained before the second densimetric separation in order to limit the introduction of water which would result in denaturing the brine bath.

In one exemplary embodiment, the alkali metal formate is potassium formate.

Such a formate salt advantageously has a lower cost compared with cesium formate.

In one exemplary embodiment, the difference between the density of the brine and the density of the energetic material does not exceed 0.05.

Such a characteristic makes it possible to further improve the efficiency of the extraction of the energetic material.

In one exemplary embodiment, the method further comprises:
an extraction of metal parts and mineral aggregates following the second densimetric separation,
an extraction of the residual alkali metal formate present on the energetic material, the metal parts and the mineral aggregates thus extracted following the second densimetric separation by rinsing with water,
a recovery of the rinse water comprising the residual alkali metal formate thus extracted, and
a concentration of the alkali metal formate by vacuum evaporation of the rinse water.

This embodiment aims at recovering the residual alkali metal formate present on the metal parts, mineral aggregates and the energetic material following the second densimetric separation, in order to make it available for subsequent reuse. This advantageously makes it possible to limit the consumption of material and therefore the cost of implementation.

In one exemplary embodiment, the energetic material is based on nitrocellulose.

The present disclosure also concerns a method for destroying solid energetic material extracted, comprising:
an extraction of the solid energetic material from the contaminated soil by means of a method as described above,
a grinding of the energetic material thus extracted, and
a destruction of the energetic material thus ground.

The invention finds particular interest in this context insofar as the grinding step no longer presents a pyrotechnic risk because of the separation of the energetic material from the metal parts and mineral aggregates.

### BRIEF DESCRIPTION OF THE DRAWINGS

FIG. 1 shows a succession of steps of an example of a method according to the invention.

### DESCRIPTION OF EMBODIMENTS

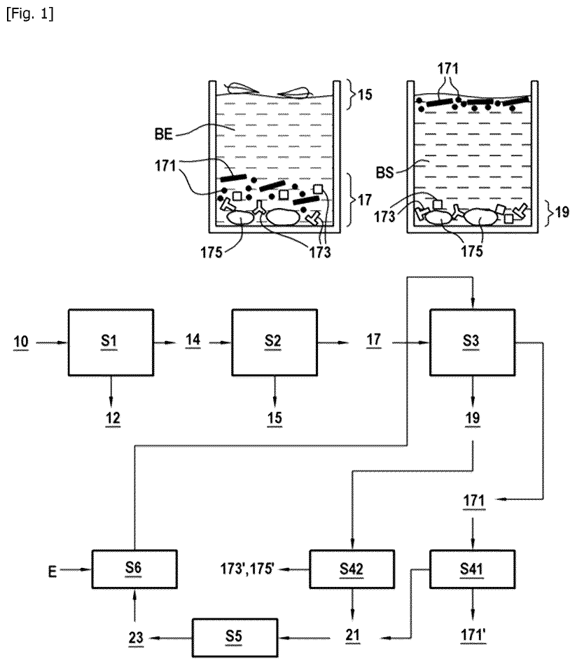

The invention will now be described by means of FIG. 1, which is present for descriptive purposes to illustrate an embodiment of the invention and which should not be interpreted as limiting it.

The method described concerns the treatment of a volume of soil 10 contaminated with an energetic material. The soil 10 comprises earth, possibly sand, mineral aggregates such as stones, plant substances (leaves, branches, etc.) and metal parts (screws, nuts, metal waste or the like), as well as the energetic material.

The soil sample 10 to be treated is first sieved and washed (step S1) so as to recover a mixture 14 comprising, in the example illustrated, the energetic material, the plant substances, the mineral aggregates and the metal parts, and to separate it from the other constituents of the soil such as earth and sand. Step S1 makes it possible to remove particles 12 of earth and sand having a dimension smaller than a predefined dimension, for example less than or equal to 2 mm. Step S1 can be carried out using a trommel, possibly under water flow to facilitate the removal of particles 12.

The mixture 14 thus recovered is immersed in a water bath BE so as to carry out a first densimetric separation between the elements present (step S2). During step S2, the plant substances 15 float on the surface of the bath BE because they have a density lower than that of water. The rest of the mixture 14 comprising the energetic material 171, the metal parts 173 and the mineral aggregates 175 flows to the bottom of the bath BE, because its constituents each have a density greater than that of water.

It will be noted that the energetic material 171 does not have a homogeneous particle size, and can, as illustrated, be in the form of a mixture of particles, having a substantially spherical shape, and plates, distinct from the particles, having an elongated shape. The skilled person will recognize that the invention can be applied to many types of energetic materials. For example, the energetic material may be an explosive material. The energetic material may be nitrocellulose-based, optionally with a plasticizer such as nitroglycerin and/or an energetic filler such as nitroguanidine. The energetic material may be poudre B. Still by way of example, the energetic material may have a nitrocellulose mass content greater than or equal to 95%, for example greater than or equal to 98%.

The first densimetric separation separates the light fraction, formed by the plant substances 15, which floats on the surface of the water bath BE, from the heavy fraction 17, comprising the energetic material 171, the metallic parts 173 and the mineral aggregates 175, which is at the bottom of the bath BE. Floating plant substances 15 are removed from the bath BE using techniques known per se, for example manually with a hand net or automatically with float recovery technologies used in the field of water treatment. The light fraction has a density lower than that of water and lower than that of the heavy fraction 17. The heavy fraction 17 has a density higher than that of water. The bath BE is then evacuated to extract the heavy fraction 17, or the heavy fraction falls into a container, for example in the form of a basket, which is removed without emptying the bath.

The heavy fraction 17 thus extracted is then dried or drained to remove the residual water present. For example, high-speed air blowing can be implemented, which is a technique suitable for automation, for example on either side of a perforated conveyor belt.

The heavy fraction 17 extracted, dried or drained, is then immersed in a bath BS of a brine, i.e., an aqueous solution, of an alkali metal formate salt, so as to carry out a second densimetric separation (step S3). The formate salt may be potassium formate or cesium formate. As indicated above, potassium formate has a lower cost than cesium formate and a sufficient density for the application case. Cesium formate is significantly more expensive but allows access to higher densities, which is useful for the extraction of energetic materials with a density greater than 1.7.

The density of the brine is a function of the formate concentration; a higher concentration results in an increase in density. The density of the brine is intermediate between that of the energetic material 171 and that of the metal parts 173. The density of the brine is also intermediate between that of the energetic material 171 and that of the mineral aggregates 175. In other words, the density of the brine is higher than the density of the energetic material 171 but lower than that of the metal parts 173 (and lower than that of the mineral aggregates 175). Thus, during step S3, the energetic material 171 floats on the surface of the bath BS because it has a density lower than that of the brine. In return, the metal parts 173 and the mineral aggregates 175 flow to the bottom of the bath BS because they each have a density greater than that of the brine and form a heavy residue 19.

Regardless of the embodiment considered, the density of the energetic material 171 may be less than or equal to 1.6. To further improve the efficiency of the separation, it may be advantageous to adjust the density of the brine to a value close to the density of the energetic material 171, while remaining higher than this density. Regardless of the embodiment considered, the difference between the density of the brine and the density of the energetic material does not exceed 0.05 or even 0.02. By way of example, the density of the energetic material 171 may be substantially equal to 1.6 and the density of the brine may be substantially equal to 1.62. Still by way of example, when potassium formate brine is used, the potassium formate concentration may be greater than or equal to 80% by mass, for example 81%. The brine may optionally be a saturated aqueous solution of potassium formate. Unless otherwise stated, the density and concentration of the brine are taken before immersion of the dried or drained heavy fraction 17.

The floating energetic material 171 is removed from the bath BS using techniques known per se, for example manually with a hand net or automatically with float recovery technologies used in the field of water treatment. The bath BS is then removed to extract heavy residue 19. As a variant, the heavy residue 19 falls into a container, for example in the form of a basket, which is removed without emptying the bath. The bath BS can be stored for future use.

It will be noted that steps S2 and S3 have the advantage of being able to be carried out at a moderate temperature, for example less than or equal to 30° C., for example comprised between 5° C. and 30° C., or even at room temperature (20° C.). This contributes to the highly safe nature of the proposed method.

The example illustrated in FIG. 1 proposes recycling the formate used for the second densimetric separation through steps S41, S42, S5 and S6 which will now be described. However, it does not exceed the scope of the invention if this recycling is omitted.

Steps S41 and S42 extract the residual alkali metal formate present on the energetic material 171 and on the heavy residue 19 after the second densimetric separation. This recovery is carried out by rinsing with water. At the end of the rinsing of step S41, an energetic material 171′ cleaned of formate is obtained. Depending on the condition of the material 171′, it can be destroyed or recycled and reintegrated into an energetic composition. The destruction of the material 171′ uses techniques known per se such as incineration, basic hydrolysis or, more advantageously, supercritical hydrothermal oxidation as described, for example, in application WO20188221. It is preceded by a grinding of the material 171′. Metal parts 173′ and mineral aggregates 175′ cleaned of formate after step S42 are also obtained.

The rinsing water 21 of steps S41 and S42 is recovered and then subjected to evaporation under vacuum in order to concentrate the residual alkali metal formate which has been extracted (step S5). It is thus possible to obtain a residual alkali metal formate brine 23 with a density adapted to its direct reuse or crystallized alkali metal formate which can then be mixed with water E, or with a brine, to obtain a concentrated brine which can be used for a new second densimetric separation (step S6).

The expression “comprised between . . . and . . . ” should be understood to include the bounds.

1. A method of extracting solid energetic material from contaminated soil comprising a mixture of energetic material with plant substances, mineral aggregates and metal parts, the method comprising:
sieving and washing of the contaminated soil to recover said mixture and remove the earth and sand possibly present,
a first densimetric separation between a light fraction comprising the plant substances and a heavy fraction comprising the energetic material, the mineral aggregates and the metal parts, by immersing the mixture thus recovered in a water bath,
extracting the heavy fraction obtained during the first densimetric separation,
drying or draining the heavy fraction thus extracted,
a second densimetric separation between the energetic material on the one hand and the metal parts and mineral aggregates on the other hand by immersing the heavy fraction thus dried or drained in a brine bath of an alkali metal formate, said brine having a density greater than that of the energetic material and less than each of the densities of the metal parts and mineral aggregates, and
extracting the energetic material obtained as a result of the second densimetric separation.

2. The method according to claim 1, wherein the alkali metal formate is potassium formate.

3. The method according to claim 1, wherein a difference between the density of the brine and the density of the energetic material does not exceed 0.05.

4. The method according to claim 1, wherein the method further comprises:
extracting metal parts and mineral aggregates following the second densimetric separation,
extracting the residual alkali metal formate present on the energetic material, the metal parts and the mineral aggregates thus extracted following the second densimetric separation by rinsing with water,
recovering the rinse water comprising the residual alkali metal formate thus extracted, and
concentrating the alkali metal formate by vacuum evaporation of the rinse water.

5. The method according to claim 1, wherein the energetic material is based on nitrocellulose.

6. A method of destroying solid energetic material extracted from contaminated soil, comprising:
extracting the solid energetic material from the contaminated soil by implementation of a method according to claim 1,
grinding the energetic material thus extracted, and
destructing the energetic material thus ground.
